(19) United States
(12) Patent Application Publication
(10) Pub. No.: US 2018/0148343 A1
(43) Pub. Date: May 31, 2018

(54) METHOD FOR PRODUCING MICROPLATES FROM SHELLS, AND MATERIAL PRODUCED BY USING THE MICROPLATES

(71) Applicant: HANBAT NATIONAL UNIVERSITY INDUSTRY-ACDEMIC COOPERATIOON FOUNDATION, Daejeon (KR)

(72) Inventors: Sang-Mo SHIN, Daejeon (KR); Jeong Ho PARK, Daejeon (KR); Dong Min KIM, Daejeon (KR); Youn Seoung LEE, Daejeon (KR)

(73) Assignee: HANBAT NATIONAL UNIVERSITY INDUSTRY-ACDEMIC COOPERATIOON FOUNDATION, Daejeon (KR)

(21) Appl. No.: 15/577,517

(22) PCT Filed: May 27, 2016
(86) PCT No.: PCT/KR2016/005669

§ 371 Date: Nov. 28, 2017

(30) Foreign Application Priority Data
May 28, 2015 (KR) 10-2015-0075336
May 27, 2016 (KR) 10-2015-0065846

(51) Int. Cl. C01F 11/18; C09C 1/02; B09B 3/00

(52) U.S. Cl. CPC C01F 11/185; B09B 3/00; C09C 1/022

(57) ABSTRACT

The present invention relates to a method for producing microplates from shells. The production method of the present invention includes a step of treating pulverized shells with an alkaline solution, thereby separating microplates of shells, and a step of producing microplates in the form of precipitate from the solution.

### TECHNICAL FIELD

The present invention relates to a method for producing microplates from shells; and a flat plate, powder of calcium carbonate and bone coal, and a calcium phosphate powder manufactured by using fine fragments of shells; and a manufacturing method thereof.

### BACKGROUND ART

Generally, Calcium carbonate powder is used in a wide variety of industries such as paper, paint, plastic, rubber, and medical. As considerable amount is used especially in paper industry, calcium carbonate powder accounts for 30% of paper weight produced. 100 million tons are produced globally, and the market size is almost 100 trillion won. About 50% of these, or about half a billion tons, are produced in China. Since hundreds of millions of tons are mined each year, in Korea, high quality limestone is depleted and large quantities are imported from China and Vietnam.

Calcium carbonate powder is currently produced in two ways. Calcium carbonate, called heavy calcium carbonate, is mostly produced by mining limestone followed by beneficiation, grinding and screening. Limestone is formed through procedures in which such as shells, corals and crustaceans have been submerged under the sea hundreds of millions of years ago and have been through high temperature, and high pressure, and elevation of the ground. The average purity of limestone is about 50%. For this reason, heavy calcium carbonate has low purity and many impurities.

High-purity calcium carbonate powder, called hard calcium carbonate, is produced through the following process. First, mined high quality limestone is calcined at a high temperature (˜1000° C. or more) to make quicklime. In this process, a large amount of carbon dioxide is emitted. Since the total atomic weight is 100 and atomic weight of carbon dioxide is 44, almost half of the weight is released to the atmosphere. When the quicklime is mixed with water, it becomes calcium hydroxide (Ca(OH)₂). When a large amount of carbon dioxide is injected again, calcium carbonate having a high purity is precipitated, which is called hard calcium carbonate.

In the process of producing these heavy calcium carbonate and hard calcium carbonate powders, millions of tons of limestone are mined per year, so one day, high-quality limestone will be depleted. In this process, not only mining facilities, beneficiation and pulverization mills, but also transportations in large amounts will be costly. In addition, the indirect costs such as environmental damage caused by mining, dust generation, respiratory diseases such as lung cancer due to dust, environmental pollution in abandoned mines, and the generation of large amounts of greenhouse gases amounting to tens of millions of tons will be charged to mankind. China, which is the main producing country, is also making efforts to solve environmental problems as a nationally important task. Since labor costs are also rising, it is now cheaper, but the price of calcium carbonate will inevitably rise in the future.

At present, there is a limitation of the calcium carbonate product itself. In the case of heavy calcium carbonate, it is difficult to make it to below a few μm in the process of pulverizing and producing the powder. In the case of hard calcium carbonate, the purity is higher and the particle size is smaller than that of the heavy calcium carbonate. However, it is also difficult to make it below a few μm in the process. Especially in the case of hard calcium carbonate, it is necessary to build a plant near the site such as a power plant where a large amount of carbon dioxide is generated because a large amount of carbon dioxide is required to be injected in the case of hard calcium carbonate.

In addition to calcium carbonate, calcium phosphate powder is a material used in dentistry/orthopedics. It is currently being resolved by self-bone grafting or by pulverizing and extracting bone from a dead body. There is a limit to the amount of bone grafting performed by autogenous bone graft, and the use of cadaveric bone grains may cause immune rejection or bacterial contamination. In Korea, it is prohibited to collect bone powder from dead bodies. However, there is a growing demand for bone powder as the number of elderly people increases and the number of osteoporosis patients increases.

On the other hand, the shell refers to the shell of shellfish and is an inorganic secretion formation that protects the soft body in molluscs. Its constituents are 95% of inorganic salts (most of which is calcium carbonate, 1-2% of which is calcium phosphate, 0.5% or less of which is magnesium carbonate) and proteinaceous conchiolin, the outermost part is covered with a shell epidermis, the next part is a stratum corneum, and the innermost part, that is, a hypostracum that touches the membrane surface of the mantle. The non-back end at the end of the mantle secreting the shell epidermis, the inner part secreting stratum corneum, and the hypostracum is made on all the surfaces of the mantle. These shells are used as paint, mordant and fertilizer in the form of powders, antacids, and ashes of burnt shells in the form of fine powders and shells of various types are also used as materials for artwork.

The shell has a structure in which microplates are aligned, is a natural material having excellent physical properties. It is known that the material has strength 3,000 times greater in weight and thickness than any material structure made by humans. However, attempts to study the structure of microplate of the shell have been carried out only through simulation studies of biomaterials, not using the shell itself, and in many countries around the world, the structure of the shell has been simulated to develop bulletproof/armored/light-weight high strength materials but all were failed. The reason for the failure is that the microplates cannot be stacked in zigzag form like in natural shells.

On the other hand, recently, abandoned shells have been buried in coastal coasts, causing serious environmental pollution including water pollution. Despite the fact that the shell has a very high value as a natural material, the development of various materials using the shell itself is not actively carried out, and the abandoned shells are still one of the main causes of environmental pollution.

In summary, the current method of producing calcium carbonate by mining limestone can lead to air pollution and diseases such as lung cancer caused by dust generated in mining and pulverization process etc., and the transportation cost due to transportation in a large amount and the generation of carbon dioxide by the transportation vehicle will cause problems. Thus, this is a situation where it is necessary to develop new alternative resources.

In addition, during the high-temperature calcination of limestone, carbon dioxide, which is a greenhouse gas of tens of millions of tons, is generated, and the fuel cost and electricity cost required for limestone high-temperature calcination are incurred, and carbon dioxide is also generated during the combustion of the fuel, which cause a global environmental problem.

In the future, the demand for calcium carbonate powders of several μm or less will be further increased in the fields of automobiles, high-grade paints, and medical industries. Therefore, it is necessary to find sources of new resource. In addition, calcium phosphate bone powder has a limited supply amount itself. There are also concerns about immunological rejection and bacterial infection.

It is necessary to take measures to solve the problems described above at once. As a substitute resource, the attention to the shells consisted of mostly calcium carbonate is growing for its abundant resources. However, at the stage of effective separation of calcium carbonate from the microplate structure of the shell, there is no satisfactory research result and there is no successful case of mass production.

A related art is Korean Patent No. 10-0221156 (a method for manufacturing a decorative finishing material for exterior use in a building using shell particles).

### DISCLOSURE

### Technical Problem

Accordingly, for the present invention, one object of the present invention is to produce a microplate composed of calcium carbonate from a shell.

It is another purpose of the present invention to produce a flat plate having excellent mechanical performance by laminating microplates produced from a shell.

It is another object of the present invention to process a surface such as a tile or a wall paper by using a microplate produced from a shell.

It is another object of the present invention to obtain a hard calcium carbonate powder from a shell.

It is another object of the present invention to obtain calcium phosphate powder having high purity from a shell.

### Technical Solution

In order to accomplish the above object, from one aspect of the present invention there is a method for producing a microplate powder from a shell, comprising the steps of (1) treating a pulverized product of shell with an alkaline solution to separate microplates of the shell (2) producing a microplate in the form of a precipitate in the solution.

According to another aspect of the present invention, there is a method for producing a microplate powder from a shell, comprising the steps of: (1) treating an acidic solution with a pulverized product of shells to separate calcium ions and carbon dioxide and collecting carbon dioxide; (2) raising pH by treating the solution in which calcium ions are separated with an alkaline solution; (3) adding the collected carbon dioxide to the solution having the increased pH to recrystallize the calcium carbonate; and (4) separating the precipitate from the solution.

Preferably, before the alkaline solution treatment or the acidic solution treatment, it further includes a pretreatment step for removing the ooze adhering to the outside of the shell and pulverizing the shell. Further, the alkaline solution treatment or the acid solution treatment step uses one or more method among a method of using thermal expansion and contraction, a method of imparting vibration using ultrasonic waves, and a method of accelerating decomposition of an internal connecting protein by irradiating ultraviolet rays. Further, the acidic solution is hydrochloric acid, and the alkaline solution is an aqueous solution of sodium hydroxide. In addition, the step of separating the calcium ion is performed at a pH of less than 2.

Another aspect of the present invention is a calcium carbonate powder produced by the above-described method.

Another aspect of the present invention is a method of producing a flat plate with a shell microplate comprising the steps of (1) aligning microplates of the shell on a substrate, (2) fixing the aligned microplates on the substrate).

Preferably, prior to the alignment step, the surface of the substrate is made hydrophilic or hydrophobic or given charge with electrification or is etched to the surface of the substrate to make the microplates well-aligned on the surface. The aligning step uses one or more method among a method of aligning the microplate on the substrate according to the flow of the fluid, a method of aligning using a 3D printing method, a method of brick cross-lamination, a continuous process method by roll-to-roll sheet. Further, the fixing step may use at least one of a method of applying or spraying an adhesive material to fix the microplate to the substrate, and a method of optically curing the microplate together with one side of the substrate.

Another aspect of the present invention is a shell microplate flat plate comprising a substrate and a shell microplate layer in which the microplates are fixedly aligned on the substrate.

According to another aspect of the present invention, there is a method of finishing a surface of an object with a shell microplate, comprising the steps of: (1) aligning the microplate of the shell with the surface of the object; and (2) fixing the aligned microplate to the surface of the object.

According to another aspect of the present invention, there is a a method for producing a hard calcium carbonate powder with a shell microplate, comprising the steps of: (1) producing a calcium ion solution by dissolving a powder of a shell microplate in an acidic liquid; and (2) precipitating crystals of calcium carbonate by adding a basic liquid to the ionic solution and injecting carbon dioxide into the solution.

According to another aspect of the present invention, there is a method for producing a calcium phosphate powder from a shell microplate comprising the steps of (1) forming a precipitate by introducing a powder of a shell microplate into a phosphate ion solution, and (2) obtaining a calcium phosphate powder by washing and drying the precipitate.

Preferably, the phosphate ion solution in the step of forming precipitate is a pyrophosphate solution.

### Advantageous Effects

According to the present invention as described above, it is possible to provide a calcium carbonate microplate powder from a shell. It is also possible to provide a flat plate having a structure in which shell microplates are uniformly aligned. In addition, shell microplates can be used in various fields such as structural materials, decorative materials, and gemstones, etc. In addition, the shell microplates can be used to produce pearls and the like having various colors on their surfaces.

In addition, it can be used in industries such as automobiles and paper by obtaining hard calcium carbonate powder of high purity from shells.

In addition, calcium phosphate powder can be obtained from shells and used as a medical material.

In addition, by using the abandoned shells of coastal coast, it is possible to prevent environmental pollution caused by abandoned shell, recycle waste, and utilize it as a new calcium carbonate resource to reduce environmental pollution caused by limestone mining.

### DESCRIPTION OF DRAWINGS

FIG. 1 illustrates a flow chart for producing a microplate from a shell according to an embodiment of the present invention and producing a flat plate, a hard calcium carbonate powder, and a calcium phosphate powder thereby.

FIG. 2 illustrates a structural diagram and crystal kinds of calcium carbonate.

FIG. 3 illustrates a process for producing a calcium carbonate powder by treating a shell with an alkaline solution in an embodiment of the present invention.

FIG. 4 illustrates a process of producing calcium carbonate powder with shells by collecting carbon dioxide and treating an alkaline solution after treating the shell with an acid solution in another embodiment of the present invention.

FIG. 5 is an EDX spectrum of the shell microplate calcium carbonate powder produced by an embodiment of the present invention and the comparative object powder prepared.

FIG. 6A to 6D are photographs of the particle size and shape of the shell microplate calcium carbonate powder produced in an embodiment of the present invention.

FIG. 7 is a graph comparing the absorbance (whiteness degree) of the shell microplate calcium carbonate powder produced in an embodiment of the present invention with the absorbance of the powder produced from limestone.

FIG. 8 illustrates a conceptual diagram of an apparatus for producing a large-area flat plate using a shell microplate calcium carbonate powder according to another embodiment of the present invention.

FIGS. 9A and 9B are photographs of the size and shape of the calcium phosphate powder produced in another embodiment of the present invention.

FIG. 10A is an EDX graph (A) of the calcium phosphate powder produced in another embodiment of the present invention, and FIG. 10B is a graph showing XRD analysis that the calcium phosphate powder produced in another embodiment of the present invention is of a Monetite crystal structure.

### BEST MODE

Hereinafter, embodiments of the present invention will be described in detail with reference to the accompanying drawings.

In the present specification, the shell refers to the shell of the shellfish, and the shellfish is collectively referred to as molluscs belonging to the bivalves. Representative shellfish include oysters, clams, shells, and abalones. In this embodiment, it is possible to utilize the discarded waste shell on the coast.

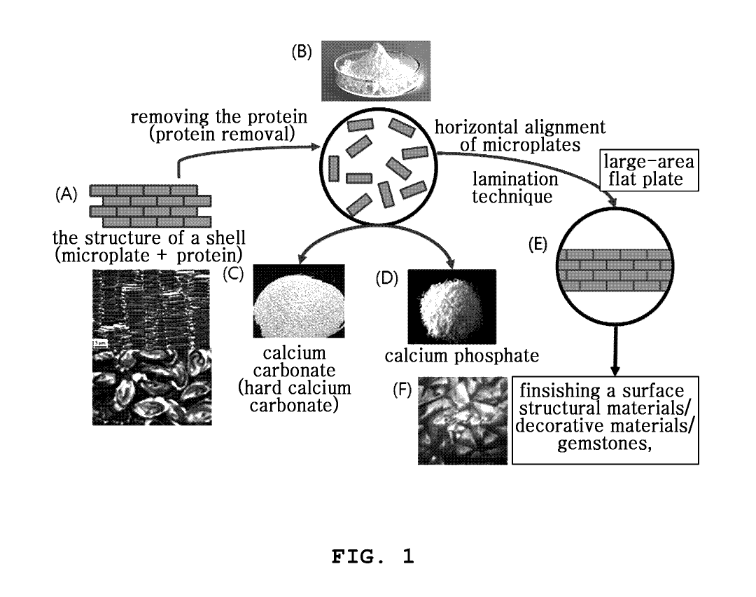

FIG. 1 is a flow chart for preparing a microplate from a shell according to an embodiment of the present invention and producing a flat plate, a hard calcium carbonate powder, and a calcium phosphate powder.

This embodiment of the present invention (FIG. 1 (A), provides treating the abandoned shells treated with an alkaline solution to remove an organic material layer containing protein to produce a microplate constituting the shell as in type of powder (FIG. 1 (B)) and laminating it to be in a uniform alignment structure, and producing a large-area flat plate having excellent mechanical performance (FIG. 1 (E)). In addition, the present embodiment provides a method of finishing the surface of a target object with various colors by using the produced microplate (FIG. 1 (F)), a method of producing calcium carbonate (hard calcium carbonate) microplate powder using the produced microplate (FIG. 1 (C)), and a method of producing calcium phosphate powder (FIG. 1 (D)).

Limestone is a shell of billions of years old. Instead of pulverizing the limestone, there is a method of making a heavy calcium carbonate powder using a shell. To adopt this method, the first step is to produce microplate from the shell. According to the results of a study by many scholars, the shell is a structure in which micrometer-sized fine sections are stacked like a brick as shown in FIG. 1 (A). When such a microplate is produced with a shell, the microplate itself can be a calcium carbonate powder of uniform size and high purity (known as 98% or more). Since the microplates are bonded to each other by the internal connecting protein and the organic substance existing between the microplates like mortar between bricks, the remaining microplates can be prepared as they are by removing the protein or by applying energy above the binding force of the protein.

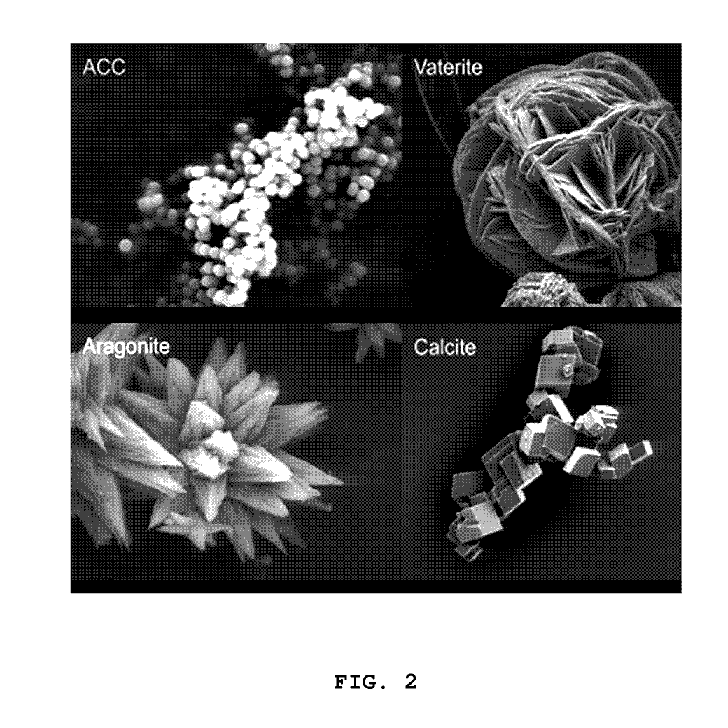

The calcium carbonate produced with the shell is eventually extracted in a crystalline form, and the crystal of calcium carbonate has a structure of calcite or aragonite as shown in FIG. 2.

In the conventional studies, a method of producing calcium carbonate powder from the shell goes through the process of i) crushing the shell or ii) preparing the calcium chloride or calcium hydroxide by treating the shell with an acidic solution and then injecting carbon dioxide at high temperature to precipitate calcium carbonate.

In this embodiment, the foreign material of the abandoned shell is first removed, and the shell is pulverized to an appropriate size (in centimeter unit or more) by applying an external force to the shell (coarse pulverization). The step of removing foreign material from the shells can be done by leaving them alone to let wind, light, animals, worms, and bacteria, and the like do the job. Or with the aid of solution containing an alkali the foreign material can be forcibly removed. Of these, one or a plurality of methods can be adopted. In the embodiment, the outside ooze is removed by natural standing for several days, and the soil is washed with water.

Further, the microplate produced from the shell can be arranged on the surface of a tile or a wallpaper to obtain a decoration effect (see FIG. 1 (F)). By adjusting the arrangement of the microplate layer and the thickness of the laminate, the color of the reflected light can be selected, thereby obtaining various colors. The pearls are mainly milk-colored and black-colored. In this way, it is possible to make various colored pearls by coating on the surface of pearls in this way.

Further, a hard calcium carbonate powder can be produced from the shell (see FIG. 1 (C)). Instead of making reaction with the calcium oxide and water to obtain calcium hydroxide as in the conventional method for producing a hard calcium carbonate, the powder from the shell or the recrystallized powder can be used as a hard calcium carbonate powder.

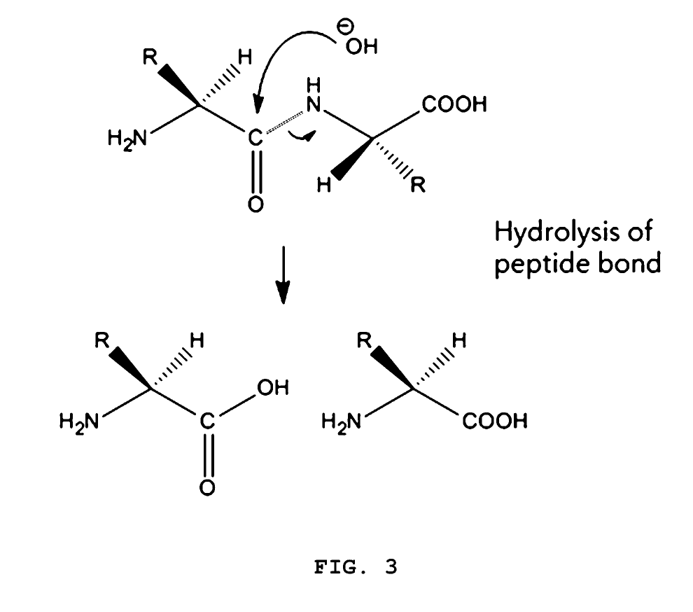

FIG. 3 is a view illustrating a process for producing a calcium carbonate powder by treating a shell with an alkaline solution in an embodiment of the present invention.

As shown in Chemical Formula 1, the shell is treated with an aqueous solution of sodium hydroxide and subjected to ultrasonic treatment at 50° C. for 4 hours to obtain calcium carbonate in powder form. This reaction is reached by hydrolysis of the peptide bond of internal connecting protein by a hydroxyl ion, and this reaction can also inhibit the loss of carbonate into the form of carbon dioxide. In this solution, the calcium carbonate microplates are precipitated and microplates are produced when the solution containing contaminants and decomposed organic materials is removed. The more frequency and time of the ultrasonic treatment are increased, the smaller size of fine powder is produced. And the size of particles can be controlled by changing treatment conditions such as reaction time, temperature and ultrasonic.

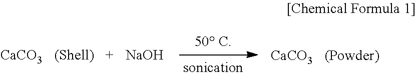

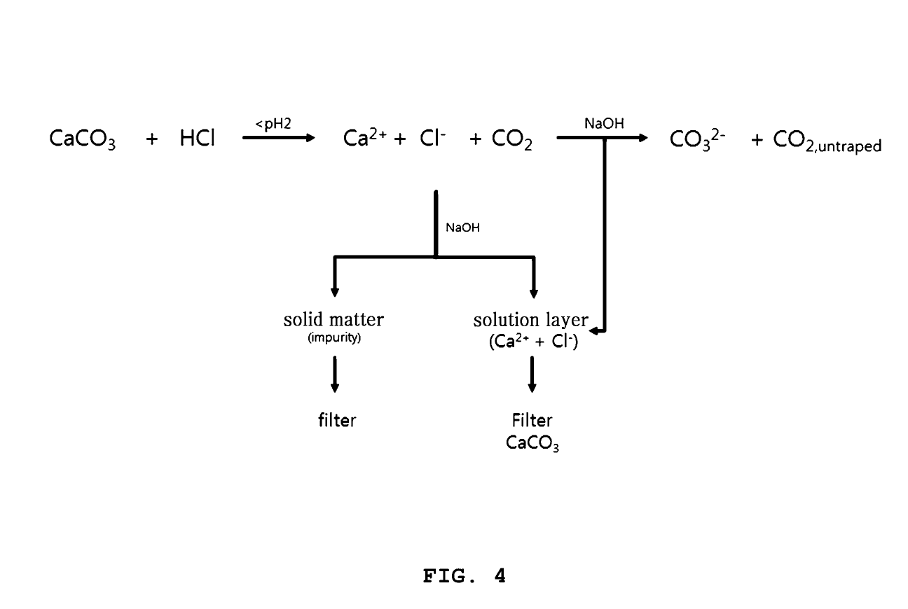

FIG. 4 illustrates a process for producing precipitated calcium carbonate (hard calcium carbonate) through recrystallization of calcium carbonate in another embodiment of the present invention.

The coarse pulverized material of the abandoned shells is put into water and the pH is adjusted to 2 or less by adding hydrochloric acid (4M concentration) as an acidic solution. As a result, calcium ions (Ca²⁺) are separated and carbon dioxide is separated into gas. When this gas is passed through a 6M sodium hydroxide solution, which is an alkaline solution, it is collected in an alkaline solution in carbonate form. The acid solution with calcium ions is treated with 6M sodium hydroxide solution to raise the pH again. Removal of the impurity solids results in calcium ions remaining in the solution layer, which are combined with carbonate ions captured in a 6M sodium hydroxide solution to form calcium carbonate crystals. When the unreacted solution is removed and filtered, a calcium carbonate powder is obtained. Through this process, hard calcium carbonate can be produced without a separate process of CO₂ elimination from the shells and reinjection of CO₂.

For aforementioned method of producing a fine powder and calcium carbonate recrystallization, one or a plurality of methods can be adopted from the following or other methods; a method of separating and reducing the adhesive force between the shell protein and the microplate using thermal expansion and contraction, a method of separating the microplate by vibration using ultrasonic waves, or a method of promoting the decomposition of the protein of the shells by irradiation of ultraviolet ray.

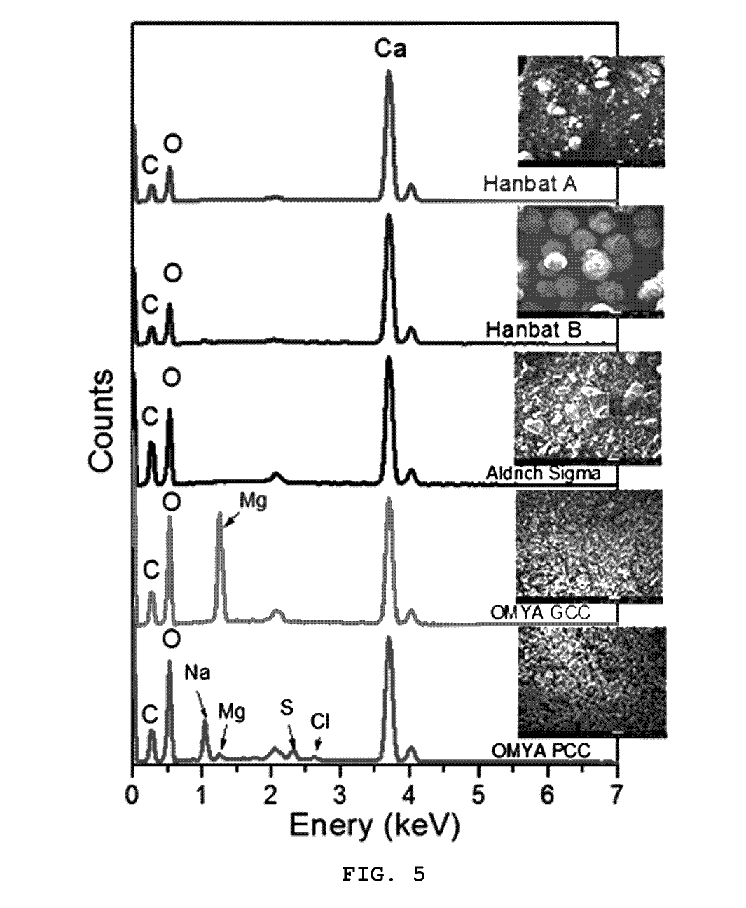

The EDX spectrum (See FIG. 5) of the calcium carbonate powder obtained as a result shows that the calcium carbonate powder of shell microplate designated by ‘Hanbat A’ (microplate produced by treatment with an alkaline solution) and ‘Hanbat B’ (calcium carbonate recrystallized by treatment of acidic solution) is well separated only into calcium, carbon, and oxygen. It can be seen that its level of purity is not lower than the reagent of Aldrich Sigma company by comparison, even has fewer impurities than a hard calcium carbonate (designated as OMYA PCC) and a heavy calcium carbonate (designated as OMYA GCC) originating from limestone by comparison.

Another embodiment for producing precipitated calcium carbonate (hard calcium carbonate) through calcium carbonate recrystallization is as follows. First, a calcium solution is produced by dissolving with an acidic ionized water liquid containing hydrogen cation. Carbon dioxide generated during this process is collected at the same time using collection equipment. Using carbon dioxide collection equipment, the generated carbon dioxide is not released to the atmosphere and is reused in a closed circuit manner in the powder producing system. An alkaline ionized water solution containing hydroxide ions and carbon dioxide collected in the previous step are injected/blown into the acid solution in which the calcium ions are dissolved from the shell, and crystals of calcium carbonate are precipitated at the bottom of the solution. The resulting crystals of calcium carbonate are washed and dried to finally produce a calcium carbonate powder. The particle size of the powder can be controlled by changing the concentration and temperature.

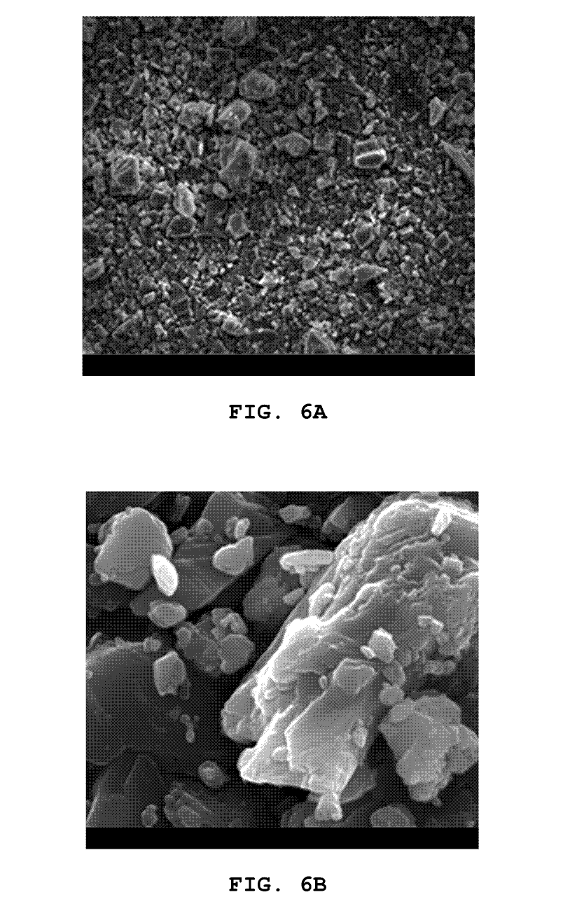

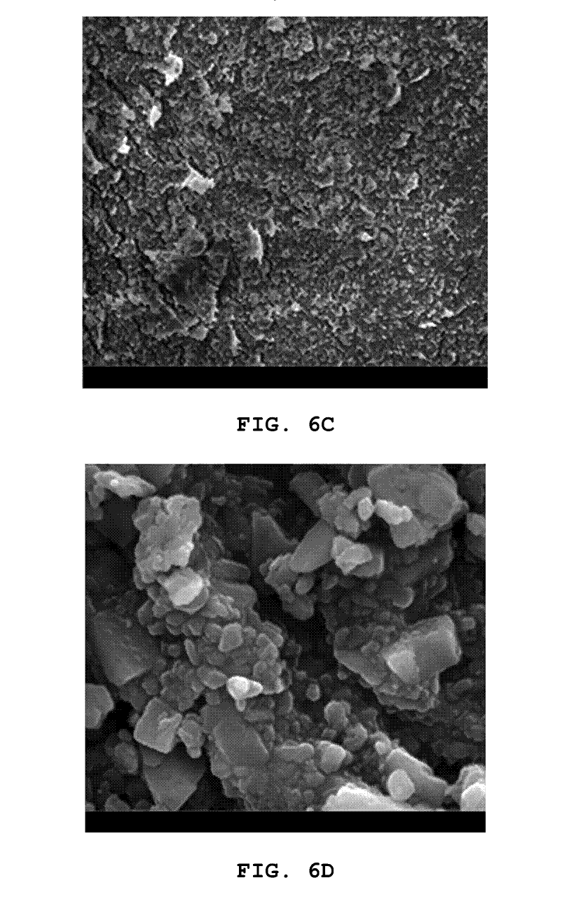

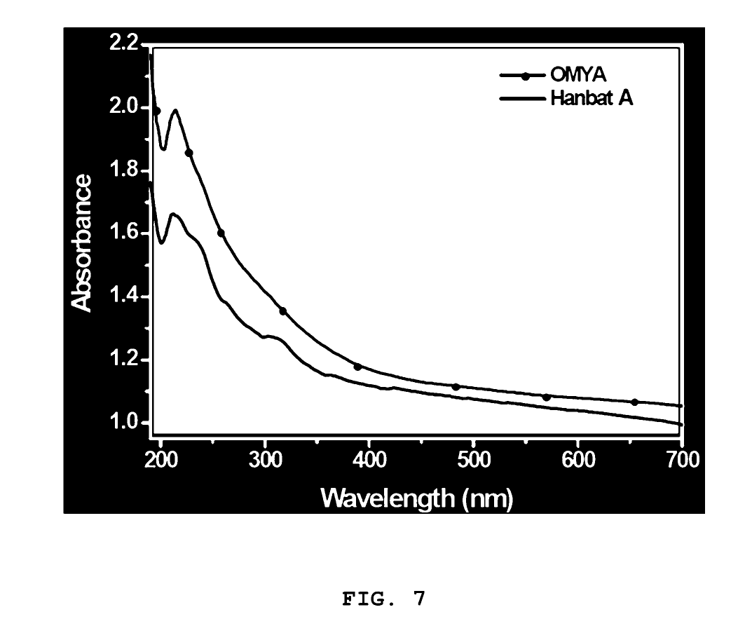

FIGS. 6A to 6D are photographs of the particle size and shape of the shell microplate calcium carbonate powder produced in the exemplary embodiment of the present invention. FIG. 6A is Omiya calcium carbonate (heavy calcium carbonate), and FIG. 6B is an enlarged view of FIG. 6A. FIG. 6C refers to calcium carbonate produced by this embodiment, and FIG. 6D is an enlarged view of FIG. 6C. As shown in FIGS. 6A to 6D, the particle size of the calcium carbonate powder obtained as a result of the producing process of this embodiment is better than the particle size of the product produced in the existing limestone with respect to crystalline property and even distribution.

FIG. 7 is a graph comparing the absorbance (whiteness degree) of the shell microplate calcium carbonate powder produced in the exemplary embodiment of the present invention with the absorbance of the powder produced from limestone.

It is confirmed that the whiteness (absorbance) of the calcium carbonate powder obtained as a result of the production of this embodiment is higher than that of the Omya powder, which is a powder originating from limestone.

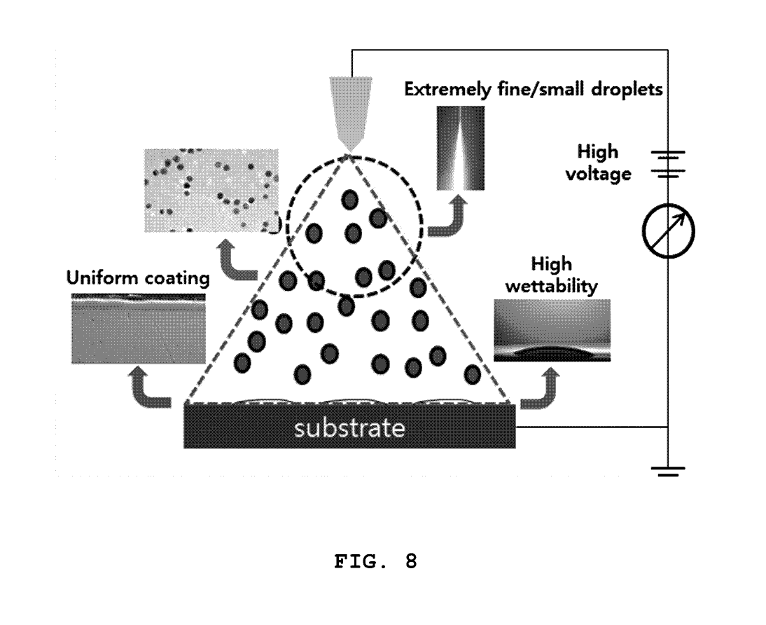

FIG. 8 illustrates a conceptual diagram of an apparatus for producing a large-area flat plate using a shell microplate calcium carbonate powder according to another embodiment of the present invention. The large-area flat plate can be produced by applying the microplate horizontal alignment technique and the lamination technique using the shell microplate powder obtained through the aforementioned process.

First, a substrate which the produced microplate powder is to be aligned to is prepared. Next, the microplate powder is aligned on the prepared substrate and the aligned microplate powder is fixed to the substrate. Next, the microplate powder of the second layer is aligned on the previously aligned and fixed microplate powder layer, and the microplate powder of the second layer is fixed. And the above process may iterate to accomplish a desired property by laminating one or a plurality of layers.

The preparation of the substrate for aligning the microplate powder includes selecting the type of the substrate and pre-treating the surface of the substrate to facilitate alignment or fixation. At this time, pretreatment can be performed by making it hydrophilic or hydrophobic or giving charge with electrification. Also, the surface of the substrate may be preprocessed by a method in which irregularities are imparted to the surface of the substrate by etching or the like so that the microplates can be aligned well.

Aligning the microplate powder on the prepared substrate includes a method of aligning the microplate powder according to the flow of the fluid, a method of aligning using the 3D printing method, a brick cross-lamination technique, a continuous process by a roll to roll sheet, etc. One or more of these methods can be adopted.

For example of the alignment process, as illustrated in FIG. 8, a powder may be contained in a droplet to form a uniform layer by releasing on the surface of the substrate.

The fixation of the aligned microplate powder is performed by spreading or spraying an adhesive an adhesive material such as lacquer, natural adhesive or artificial adhesive, or by optically curing. One or more of these methods can be adopted.

In the structure where the microplates are stacked like bricks, the impact energy is absorbed as the progress of the fracture due to the external mechanical impact proceeds in a zigzag manner. A lightweight and high strength structure like a shell can be obtained by aligning the microplate powder produced from the shell evenly and laminating the flat surfaces.

An exemplary embodiment of producing calcium phosphate powder from shells is as follows. First, a microplate powder produced from shells or shells are put into a phosphate ion solution (of pH less than 2) to form a precipitate. In this process, the phosphoric acid ion of the phosphate ion solution and the calcium carbonate component of the shell react with each other to produce calcium phosphate, and the carbonic acid is gasified as carbon dioxide and removed. The precipitated calcium phosphate crystals are washed and dried to finally produce a calcium phosphate powder. In this process, a phosphoric acid or pyrophosphate solution can be used as the phosphate ion solution.

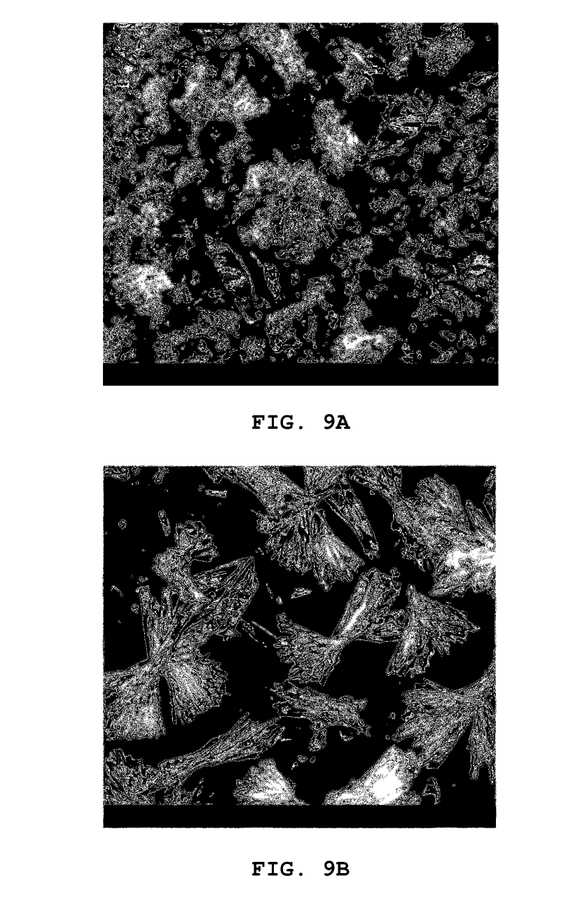

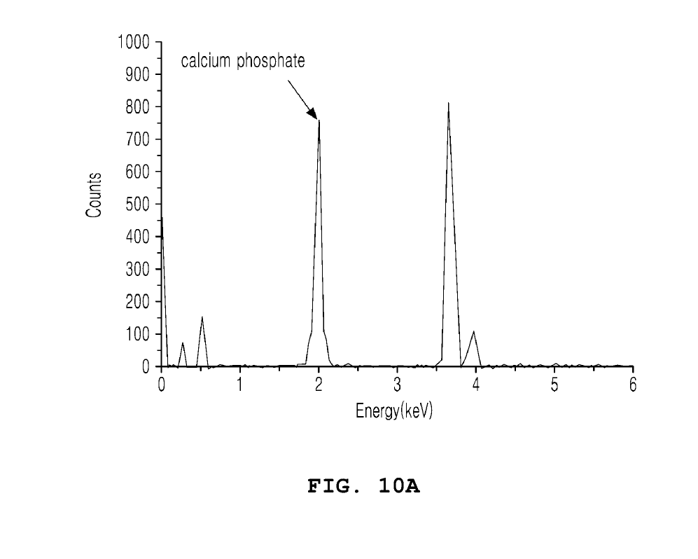

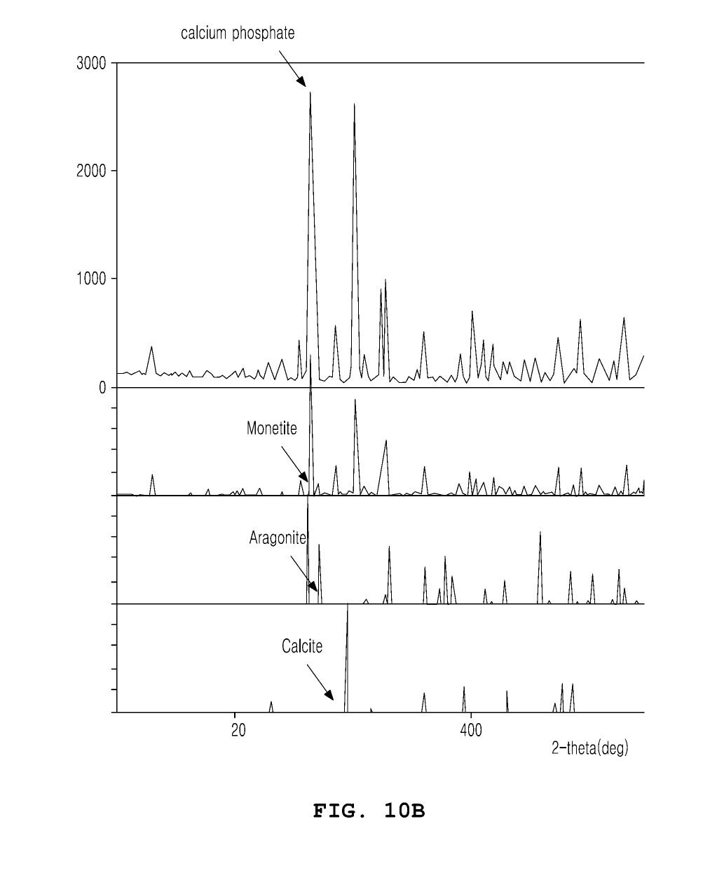

FIGS. 9A and 9B are photographs of the size and shape of the calcium phosphate powder produced in another embodiment of the present invention. FIG. 10A is an EDX graph of calcium phosphate powder produced in another embodiment of the present invention, and FIG. 10B is a graph (B) showing XRD analysis that the calcium phosphate powder produced in another embodiment of the present invention is of Monetite crystal structure.

As shown in FIG. 10A, the structure of the calcium phosphate powder is of a high purity. As illustrated in FIG. 10B, the peak is the same as the peak of the monetite crystal structure, so that the monetite crystal structure is the main structure.

The exemplary embodiments of the present invention have been described in detail above. It will be apparent to those skilled in the art that this specific description is merely a preferred embodiment and that the scope of the invention is not limited thereto. Accordingly, the actual scope of the present invention will be defined by the appended claims and their equivalents.

1. A method for producing a microplate powder from a shell, comprising the steps of:
(1) treating pulverized material of the shell with an alkaline solution to separate the microplates of the shell; and
(2) producing a microplate in the form of a precipitate in the solution.

2. A method for producing a microplate powder from a shell, comprising the steps of:
(1) separating calcium ions and carbon dioxide by treating the pulverized shell with an acidic solution, and collecting carbon dioxide;
(2) treating the solution in which the calcium ions are separated with an alkaline solution to raise the pH;
(3) recrystallizing the calcium carbonate by adding the collected carbon dioxide to the solution having the increased pH; and
(4) separating the precipitate from the solution.

3. The method for producing a microplate powder from a shell according to claim 1, further comprising a pretreatment step for removing the ooze and the like adhering to the outside of the shell and for pulverizing the shell before the alkaline solution treatment or the acidic solution treatment.

4. The method for producing a microplate powder from a shell according to claim 1,
wherein the step of the alkaline solution treatment or the acid solution treatment further uses one or more method among a method of using thermal expansion and contraction, a method of imparting vibration using ultrasonic waves, and a method of accelerating decomposition of an internal connecting protein by irradiating ultraviolet rays.

5. The method for producing a microplate powder from a shell according to claim 1,
wherein the alkaline solution is an aqueous solution of sodium hydroxide.

6. The method for producing a microplate powder from a shell according to claim 2,
wherein the acid solution is hydrochloric acid and the alkaline solution is an aqueous solution of sodium hydroxide.

7. The method for producing a microplate powder from a shell according to claim 2,
wherein the step of separating calcium ions is performed at a pH of less than 2.

8. A calcium carbonate powder produced by the method of claim 1.

9. A method for producing a flat plate with shell microplate, comprising the steps of;
(1) aligning microplates of the shell on a substrate;
(2) fixing the aligned microplates to the substrate.

10. The method for producing a flat plate with shell microplate according to claim 9,
wherein the surface of the substrate is made hydrophilized, hydrophobic, or electrified by imparting electric charge to the surface of the substrate or etched to impart irregularities to the surface, before the aligning step so that the microplates can be well aligned on the surface.

11. The method for producing a flat plate with shell microplate according to claim 9,
wherein the aligning step utilizes one or more method among a method of aligning the microplate with the substrate according to a flow of fluid, a method of aligning using a 3D printing method, a brick cross-lamination method, and a continuous process by roll-to-roll sheet.

12. The method for producing a flat plate with shell microplate according to claim 9,
wherein the fixing step utilizes one or more method among spreading or spraying an adhesive material to fix the microplate to the substrate, and a method of optically curing the microplate together with one side of the substrate.

13. A flat plate with shell microplate comprising:
a substrate; and
a microplate layer of the shells which is aligned and fixed on the substrate.

14. A method for finishing a surface of a target object with a shell microplate, comprising the steps of;
(1) aligning the shell microplates on the surface of the object; and
(2) fixing the aligned microplates to the surface of the object.

15. A method for producing a hard calcium carbonate powder with a shell microplate, comprising the steps of;
(1) producing a calcium ion solution by dissolving a powder of a shell microplate in an acidic liquid; and
(2) adding an alkaline liquid to the produced calcium ion solution, and injecting carbon dioxide into the solution to precipitate crystals of calcium carbonate.

16. A method for producing a calcium phosphate powder with a shell microplate, comprising the steps of;
(1) putting a powder of a shell microplate into a phosphate ion solution to form a precipitate; and
(2) washing and drying the precipitate to obtain calcium phosphate powder.

17. The method for producing a calcium phosphate powder with a shell microplate according to claim 16,
wherein the phosphate ion solution in the step for forming a precipitate is a pyrophosphate solution.

18. The method for producing a microplate powder from a shell according to claim 2, further comprising a pretreatment step for removing the ooze and the like adhering to the outside of the shell and for pulverizing the shell before the alkaline solution treatment or the acidic solution treatment.

19. The method for producing a microplate powder from a shell according to claim 2,
wherein the step of the alkaline solution treatment or the acid solution treatment further uses one or more method among a method of using thermal expansion and contraction, a method of imparting vibration using ultrasonic waves, and a method of accelerating decomposition of an internal connecting protein by irradiating ultraviolet rays.

20. A calcium carbonate powder produced by the method of claim 2.
